(19) United States
(12) Patent Application Publication
(10) Pub. No.: US 2026/0301123 A1
(43) Pub. Date: Oct. 1, 2026

(54) IMAGE PROCESSING DEVICE, IMAGE PROCESSING METHOD, AND PROGRAM

(71) Applicant: SONY GROUP CORPORATION, TOKYO (JP)

(72) Inventors: MASAKO KOMURO, TOKYO (JP); YOSHIYUKI TAKAO, TOKYO (JP)

(21) Appl. No.: 19/100,838

(22) PCT Filed: Jul. 25, 2023
(86) PCT No.: PCT/JP2023/027189

§ 371 Date: Dec. 12, 2025

(30) Foreign Application Priority Data
Aug. 8, 2022 (JP) 2022-126503

(51) Int. Cl. G06T 5/50; G06T 7/162; G06T 7/194; G06V 10/764

(52) U.S. Cl. CPC G06T 5/50; G06T 7/162; G06T 7/194; G06V 10/764; G06T 2207/20221

(57) ABSTRACT

The present technology relates to an image processing device, an image processing method, and a program capable of accurately extracting a silhouette of a subject. An image processing device of the present technology includes a merge processing unit configured to merge a first silhouette image output from a first learning model that takes, as input, a captured image in which a subject and a background appear and a background image in which the background appears, and outputs a silhouette image indicating a region of the subject in the captured image, and a second silhouette image generated by using a method for generating the silhouette image by performing object recognition on the captured image. The present technology can be applied to, for example, an image processing device that extracts a silhouette of a subject from a captured image for use in generating a 3D model.

### TECHNICAL FIELD

The present technology relates to an image processing device, an image processing method, and a program, and more particularly, to an image processing device, an image processing method, and a program capable of accurately extracting a silhouette of a subject.

### BACKGROUND ART

There is a technology of generating a 3D model of a subject from moving images captured from multiple viewpoints and generating a virtual viewpoint image of the 3D model according to an arbitrary viewpoint position to provide an image of a free viewpoint. Such a technology is also called volumetric capture or the like.

In the generation of a 3D model, it is necessary to separate the subject and the background appearing in each captured image captured from multiple viewpoints and extract the silhouette of the subject from the captured image. For example, Patent Document 1 describes a technique for extracting a silhouette of a subject from a distance image indicating the distance between the subject and the imaging device. Furthermore, for example, the silhouette of a subject can be extracted from a captured image by a foreground/background difference method that uses a difference between a background image acquired by capturing only the background in advance and a captured image acquired by capturing in a state where a subject such as a person actually exists.

### CITATION LIST

### Patent Document

Patent Document 1: Japanese Patent Application Laid-Open No. 2021-124868.

### SUMMARY OF THE INVENTION

### Problems to be Solved by the Invention

It is desirable that a silhouette can be accurately extracted from a captured image under any condition, but in the foreground/background difference method or the like, the silhouette cannot be accurately extracted depending on the situation. If the silhouette cannot be accurately extracted, it is necessary to manually correct the extracted silhouette, which requires work man-hours.

The present technology has been made in view of such a circumstance, and enables accurate extraction of a silhouette of a subject.

### Solutions to Problems

An image processing device of one aspect of the present technology includes a merge processing unit configured to merge a first silhouette image output from a first learning model that takes, as input, a captured image in which a subject and a background appear and a background image in which the background appears, and outputs a silhouette image indicating a region of the subject in the captured image, and a second silhouette image generated by using a method for generating the silhouette image by performing object recognition on the captured image.

An image processing method of one aspect of the present technology includes merging, using an image processing device, a first silhouette image output from a first learning model that takes, as input, a captured image in which a subject and a background appear and a background image in which the background appears, and outputs a silhouette image indicating a region of the subject in the captured image, and a second silhouette image generated by using a method for generating the silhouette image by performing object recognition on the captured image.

A program of one aspect of the present technology is a program for causing a computer to execute processing of merging a first silhouette image output from a first learning model that takes, as input, a captured image in which a subject and a background appear and a background image in which the background appears, and outputs a silhouette image indicating a region of the subject in the captured image, and a second silhouette image generated by using a method for generating the silhouette image by performing object recognition on the captured image.

In one aspect of the present technology, a first silhouette image output from a first learning model that takes, as input, a captured image in which a subject and a background appear and a background image in which the background appears, and outputs a silhouette image indicating a region of the subject in the captured image, and a second silhouette image generated by using a method for generating the silhouette image by performing object recognition on the captured image are merged.

### BRIEF DESCRIPTION OF DRAWINGS

FIG. 1 is a diagram for briefly describing generation of a 3D model of a subject and display of a free viewpoint image using the 3D model.

FIG. 2 is a diagram illustrating an example of a silhouette image acquired by a foreground/background difference method.

FIG. 3 is a diagram illustrating an example of silhouette images acquired by the foreground/background difference method and a learning-type foreground/background difference method.

FIG. 4 is a diagram illustrating details of a silhouette image acquired by the learning-type foreground/background difference method.

FIG. 5 is a diagram illustrating a flow of acquiring a silhouette image by graph cut.

FIG. 6 is a diagram illustrating a flow of acquiring a silhouette image by MaskRCNN.

FIG. 7 is a diagram illustrating a first example of silhouette image merging processing.

FIG. 8 is a diagram illustrating details of a method for generating a mask for graph cut and details of each silhouette image to be merged.

FIG. 9 is a diagram illustrating a second example of silhouette image merging processing.

FIG. 10 is a diagram illustrating the second example of silhouette image merging processing.

FIG. 11 is a block diagram illustrating a functional configuration example of an image processing device.

FIG. 12 is a flowchart illustrating processing performed by an image processing device in a case where a silhouette image acquired by a learning-type foreground/background difference method and a silhouette image acquired by graph cut are merged.

FIG. 13 is a flowchart illustrating processing performed by the image processing device in a case where a silhouette image acquired by the learning-type foreground/background difference method and a silhouette image acquired by MaskRCNN are merged.

FIG. 14 is a diagram illustrating a third example of silhouette image merging processing.

FIG. 15 is a block diagram illustrating a configuration example of hardware of a computer.

### MODE FOR CARRYING OUT THE INVENTION

Hereinafter, modes for carrying out the present technology will be described. The description is given in the following order.
1. Overview of volumetric capture
2. Method for extracting silhouette
3. Configuration and operation of image processing device
4. Modifications

### 1. Overview of Volumetric Capture

An image processing device according to the present technology relates to volumetric capture that generates a 3D model of a subject from moving images captured from multiple viewpoints and generates a virtual viewpoint image of the 3D model corresponding to an arbitrary viewing position to provide an image of a free viewpoint (free viewpoint image).

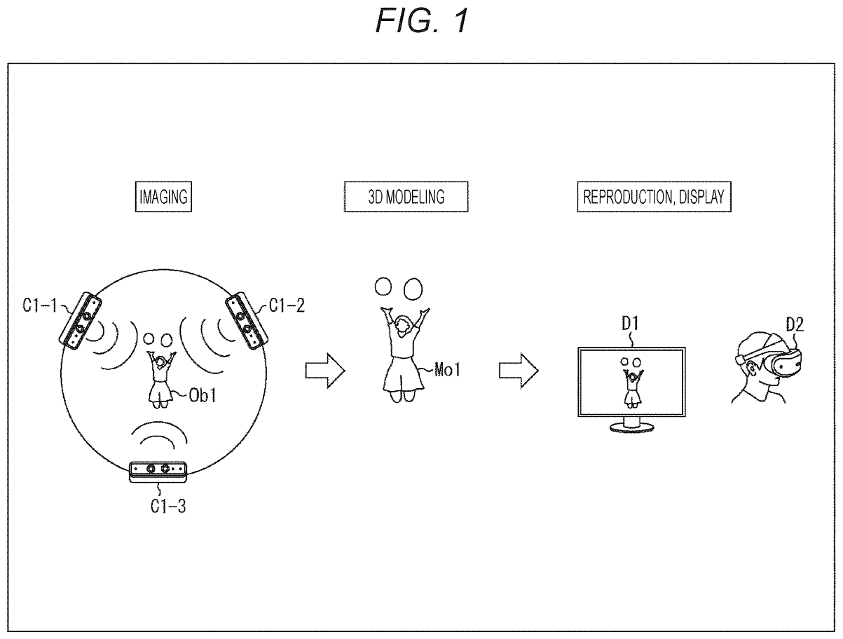

Accordingly, first, the generation of a 3D model of a subject and display of a free viewpoint image using the 3D model will be briefly described with reference to FIG. 1.

For example, a plurality of captured images can be acquired by imaging a predetermined imaging space in which a subject is arranged with a plurality of imaging devices from the outer periphery of the imaging space. The captured images may be constituted by moving images, for example. In the example of FIG. 1, three imaging devices C1-1 to C1-3 are disposed to surround a subject Ob1, but the number of imaging devices C1 is not limited to three and may be any number. Since the number of imaging devices C1 at the time of imaging is the known number of viewpoints when a free viewpoint image is generated, the free viewpoint image can be expressed with higher accuracy as the number is larger. The subject Ob1 in FIG. 1 is a person performing a predetermined motion.

3D modeling is performed using the captured images acquired from the plurality of imaging devices C1 arranged at different positions, and a 3D model Mol of the subject Ob1 is generated as illustrated in the center of FIG. 1. The 3D model Mo1 is generated, for example, by a method such as Visual Hull, which cuts out a three-dimensional shape using captured images acquired by capturing the subject Ob1 from different directions.

The data (3D model data) of the 3D model Mol generated as described above is transmitted to a device on the reproduction side and reproduced. That is, the 3D shape image is displayed on a viewing device by rendering the 3D model on the basis of the 3D model data in the device on the reproduction side. On the right side of FIG. 1, a display D1 and a head mounted display (HMD) D2 are illustrated as viewing devices used by the viewer.

### 2. Method for Extracting Silhouette

In the generation of the 3D model, it is necessary to separate the subject and the background appearing in each captured image and extract the silhouette of the subject from each captured image. The silhouette extracted from the captured image is indicated by, for example, a silhouette image as an image in which the pixel value of the region of the subject (foreground) is 1 and the pixel value of the region of the background other than the subject is 0.

Examples of the methods for extracting the silhouette include the following four techniques.
Foreground/background difference method
Learning-type foreground/background difference method
Graph cut
MaskRCNN

Hereinafter, details of each of the four extraction methods will be described. Hereinafter, for ease of understanding, the captured image will be described as a still image. In a case where the captured image is constituted by a moving image, a similar extraction method is applied to each frame image constituting the captured image.

### Foreground/Background Difference Method

The foreground/background difference method is a method for extracting a silhouette of a subject from a captured image by determining a difference between a background image acquired by imaging only the background in advance and a captured image acquired by imaging in a state where a subject such as a person actually exists.

In the foreground/background difference method, in a case where the hue of the foreground (subject) and the hue of the background are clearly different, the silhouette of the subject can be easily extracted. In addition, in the foreground/background difference method, a process of performing learning is not necessary.

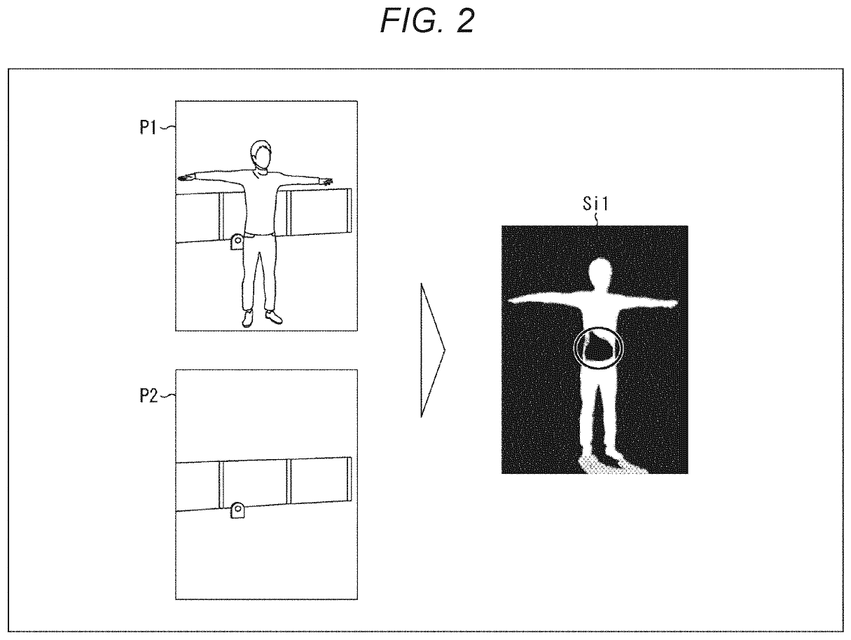

FIG. 2 is a diagram illustrating an example of a silhouette image acquired by the foreground/background difference method.

In the foreground/background difference method, for example, a silhouette image Si1 illustrated on the right side of FIG. 2 is acquired by determining a difference between a captured image P1 and a background image P2 illustrated on the left side of FIG. 2.

In the foreground/background difference method, in a case where the color of the subject and the color of the background are the same or similar, a part of the subject is recognized as the background, and a hole or a missing part may be created in a partial region of the silhouette of the subject as indicated by being surrounded by an ellipse in the silhouette image Si1. Also, in the foreground/background difference method, the shadow of the subject is also recognized as the subject, and the shadow of the subject may be included in the silhouette as indicated by hatching in the silhouette image Si1. In an outdoor environment in which the background changes with the lapse of time, the color of the background appearing in the background image is different from the color of the background appearing in the captured image, and thus the silhouette of the subject may not be accurately extracted.

### Learning-Type Foreground/Background Difference Method

The learning-type foreground/background difference method is a method for acquiring a silhouette image using a learning model that takes a background image and a captured image as input and outputs a silhouette image. The learning model is acquired, for example, by learning a difference between the hue of the foreground and the hue of the background and whether each region of the captured image is a foreground region or a background region.

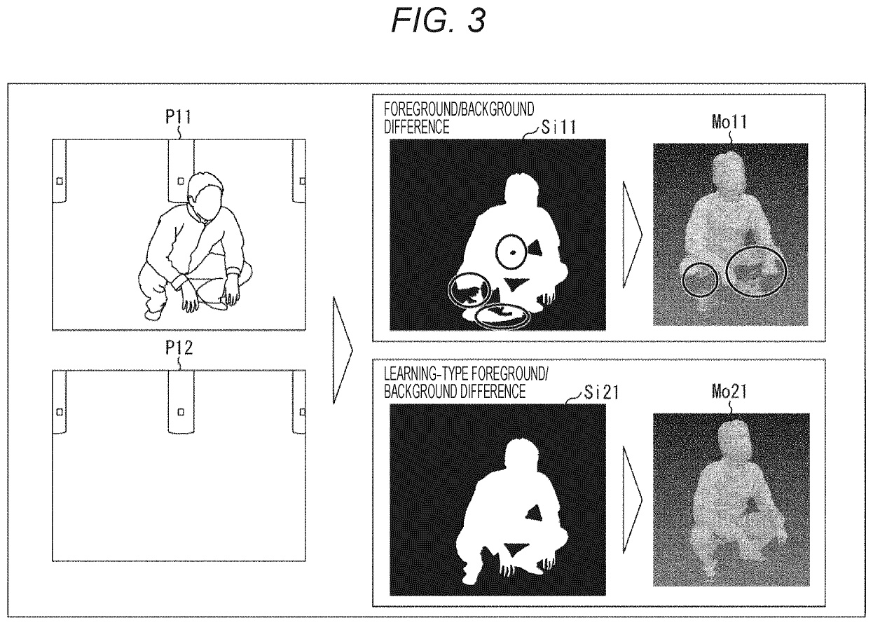

FIG. 3 is a diagram illustrating examples of silhouette images acquired by the foreground/background difference method and the learning-type foreground/background difference method.

In the foreground/background difference method, a silhouette image Si11 illustrated in the upper center of FIG. 3 is acquired by using a difference between a captured image P11 and a background image P12 illustrated on the left side of FIG. 3. In the silhouette image Si11, as illustrated by being surrounded by ellipses, a hole is created in a partial region of the silhouette, and some parts of the region of the silhouette are missing. Also, in the silhouette image Si11, the shadow of the subject is included in the silhouette.

When the three-dimensional shape is cut out using such a silhouette image Si11, a 3D model Moll illustrated in the upper right of FIG. 3 is generated. Since parts of the region corresponding to the leg portion of the person are missing in the silhouette indicated by the silhouette image Si11, parts of the leg portion of the 3D model Moll are missing as indicated by being surrounded by ellipses.

On the other hand, in the learning-type foreground/background difference method, when the captured image P11 and the background image P12 are input to the learning model, a silhouette image Si21 illustrated in the lower center of FIG. 3 is output from the learning model. In the silhouette image Si21, a region that is not recognized as the subject by the foreground/background difference method is recognized as the subject, and no hole or missing part is created in the silhouette. Also, in the silhouette image Si21, the shadow of the subject is not included in the silhouette.

As described above, the learning-type foreground/background difference method can extract the silhouette of the subject from the captured image more robustly than the foreground/background difference method.

When the three-dimensional shape is cut out using the silhouette image Si21, a 3D model Mo21 in which none of the portions is missing is generated as illustrated in the lower right side of FIG. 3.

Note that it is possible to enhance the accuracy of the silhouette extracted by the learning model that realizes the learning-type foreground/background difference method by accumulating learning using an image group similar in imaging situation as learning data.

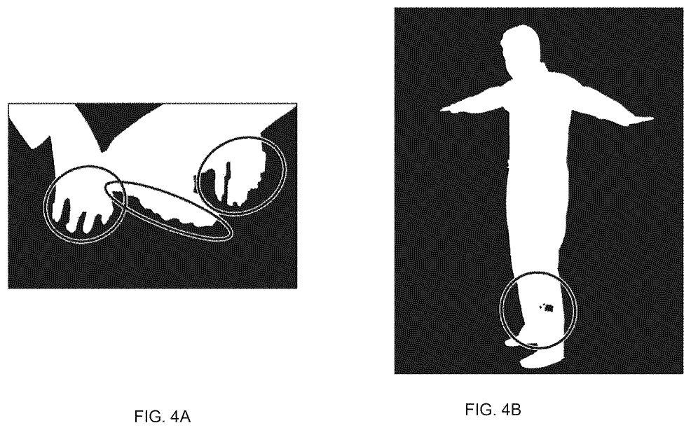

In the learning-type foreground/background difference method, since the boundary portion (edge) between the subject and the background is determined by performing inference on the reduced captured image and enlarging the inference result to perform threshold processing, the edge may not be accurately determined. For example, as illustrated by ellipses in A of FIG. 4, the edges of the finger and the foot are not smoothly extracted, so that the silhouette includes a background or is partially missing.

In addition, in the learning-type foreground/background difference method, there is a possibility that a hole or a missing part is created in the silhouette depending on the imaging situation. For example, in a case where a silhouette is extracted from a captured image captured in an imaging situation of insufficient learning, a hole may be created in a partial region of the silhouette as indicated by an ellipse in B of FIG. 4. In the learning-type foreground/background difference method, it is necessary to use an appropriate learning model according to the imaging situation or the like in order to reduce the creation of holes or missing parts in the silhouette.

### Graph Cut

The graph cut is a method for acquiring a silhouette image using an interactive algorithm in which a user who desires to extract a silhouette designates a region indicating a part of the foreground, a region indicating a part of the background, and a region for which it is unclear whether it is foreground or background, and extracts a silhouette while narrowing the region in the captured image.

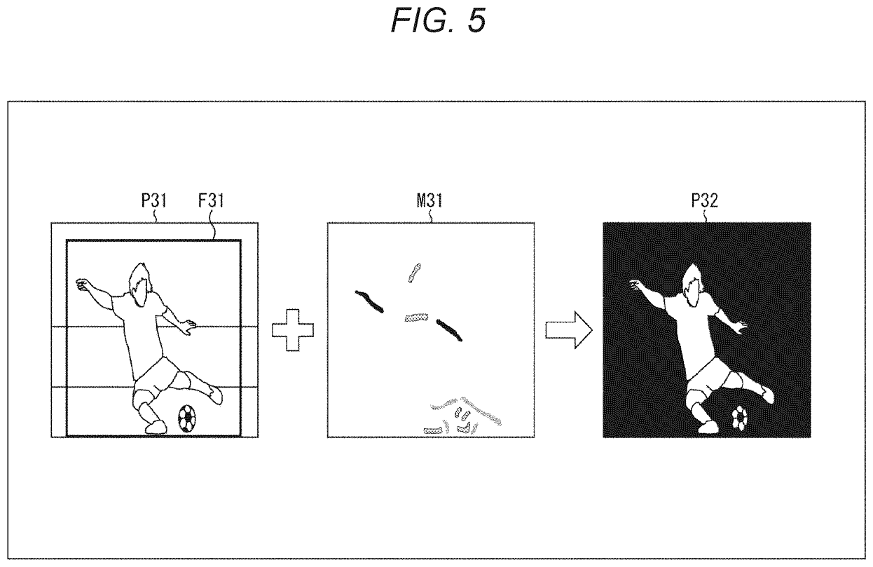

FIG. 5 is a diagram illustrating a flow of acquiring a silhouette image by graph cut.

First, for example, the user designates a region indicated by a frame F31 in a captured image P31 illustrated on the left side of FIG. 5 as a region including a subject.

Next, the user performs an operation of drawing a region indicating a part of the foreground in the captured image, a region indicating a part of the background, and a region for which it is unclear whether it is foreground or background, and creating a mask M31 illustrated in the center of FIG. 5. In the mask M31, the hatched region is a region indicating a part of the foreground, the black region is a region indicating a part of the background, and the gray region is a region for which it is unclear whether it is foreground or background.

When the graph cut is performed on the captured image P31 using the mask M31, an image P32 including only the foreground is acquired as illustrated on the right side of FIG. 5. A silhouette image is acquired by performing conversion processing on the image P32.

In the graph cut, the edge of the silhouette can be accurately extracted, and the silhouette can be extracted without creating holes or missing parts in the region designated as the region indicating a part of the foreground by the mask.

However, in the graph cut, it is necessary for the user to manually designate a region indicating a part of the foreground or a region indicating a part of the background. Also, in the graph cut, when the foreground and the background are not accurately distinguished even if the graph cut is executed once, it is necessary for the user to repeatedly perform the operation of designating the region indicating a part of the foreground or the region indicating a part of the background to correct the image output as the processing result of the graph cut.

### MaskRCNN

MaskRCNN is a multi-tasking method that simultaneously performs generic object detection and instance segmentation.

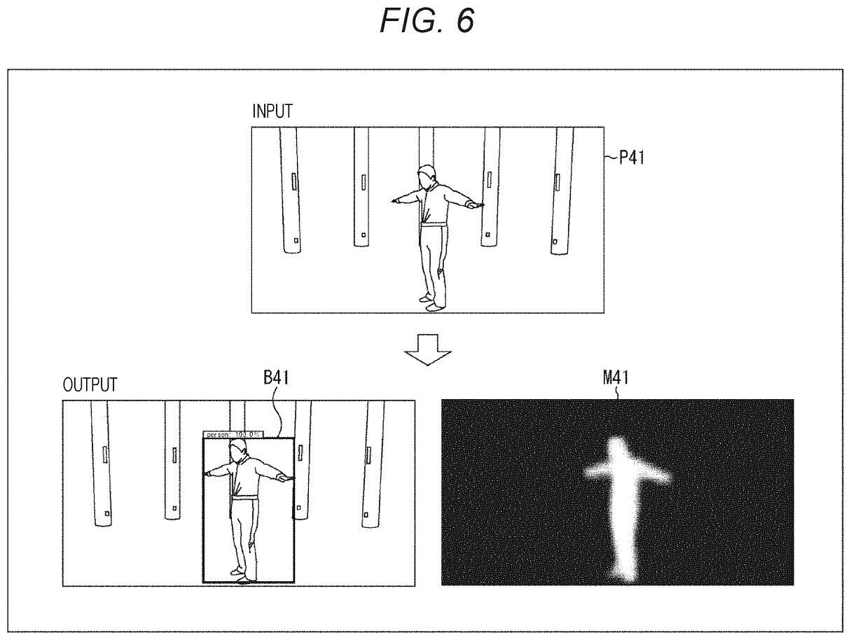

FIG. 6 is a diagram illustrating a flow of acquiring a silhouette image by MaskRCNN.

In MaskRCNN, for example, a captured image P41 illustrated on the upper side of FIG. 6 is input to a learning model that recognizes a region of an object in a captured image and a class (object type) indicated by the region of the object. When the captured image P41 is input, the learning model outputs a recognition result of the class of the object appearing in the captured image P41 illustrated on the lower left side of FIG. 6 and a mask M41 illustrated on the lower right side of FIG. 6.

In the example of FIG. 6, the recognition result of the class of the object appearing in the captured image P41 includes a bounding box B41 surrounding the person appearing in the captured image P41 and the text “person: 100.0%” appearing on the upper side of the bounding box B41. In the MaskRCNN, the text “person: 100.0%” indicates that an object appearing in the captured image P41 is a person and the probability that the object is a person.

The mask M41 indicates a region of the person in the captured image P41. A silhouette image is acquired by performing conversion processing on the mask M41. In the MaskRCNN, for example, pixels having a high probability of capturing a person among all the pixels in the captured image P41 are recognized as a person region, and thus, the accuracy of identifying the boundary between the person and the background is low. Therefore, the accuracy of the edge of the silhouette indicated by the silhouette image acquired by converting the mask M41 is low.

In the MaskRCNN, segmentation of a region of a person is performed after recognizing that a person appears in the captured image. Therefore, recognition of an unnatural region as the region of a person, such as recognition of a region including a hole as the region of a person, does not occur, and a silhouette in which a hole or a missing part is not created can be acquired.

### Silhouette Extraction Method of Present Technology

As described above, the four extraction methods have good cases and weak cases. Therefore, an embodiment of the present technology proposes a technology capable of accurately extracting a silhouette of a subject by merging a first silhouette image acquired by a learning-type foreground/background difference method and a second silhouette image acquired by using a method for generating a silhouette image by performing object recognition on a captured image.

Examples of a method for generating a silhouette image by performing object recognition on a captured image include a method in which bone estimation and graph cut of a subject appearing in a captured image are combined, and MaskRCNN.

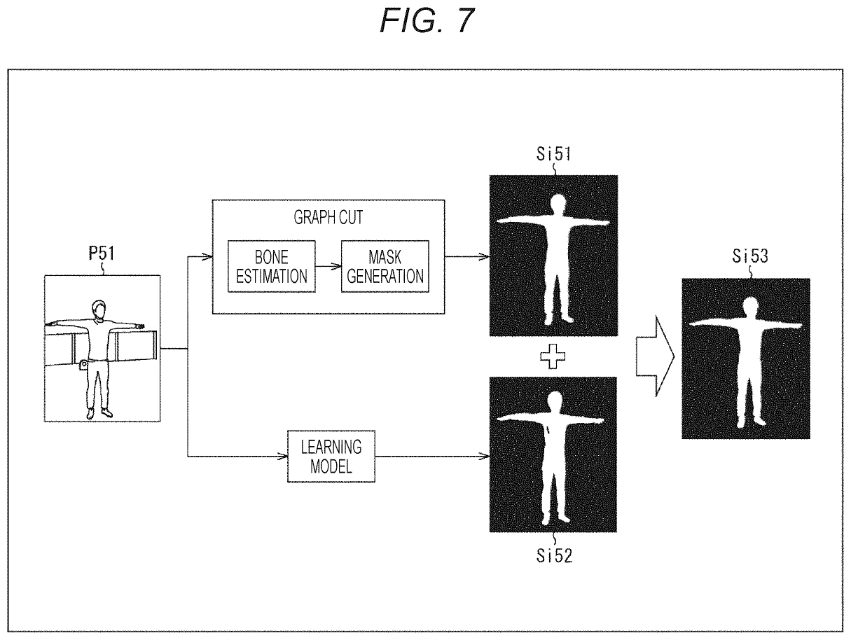

FIG. 7 is a diagram illustrating a first example of silhouette image merging processing.

In the example of FIG. 7, a silhouette image Si51 is acquired by performing graph cut on a captured image P51, and a silhouette image Si52 is acquired by inputting the captured image P51 (and the background image) to a learning model that realizes the learning-type foreground/background difference method.

In the graph cut in the present technology, first, bone estimation of the subject appearing in the captured image P51 is performed as object recognition on the captured image P51, and a line (bone) connecting the positions of joints of the subject is estimated. Next, a mask for graph cut for designating a region indicating a part of the foreground and a region indicating a part of the background in the captured image is generated on the basis of the result of the bone estimation. The silhouette image Si51 is acquired by graph cut using the mask. Since the mask for graph cut is generated on the basis of bone estimation on the captured image, it is possible to extract a silhouette from the captured image without the user manually designating a region indicating a part of the foreground.

The silhouette image Si51 and the silhouette image Si52 are merged to generate a final silhouette image Si53.

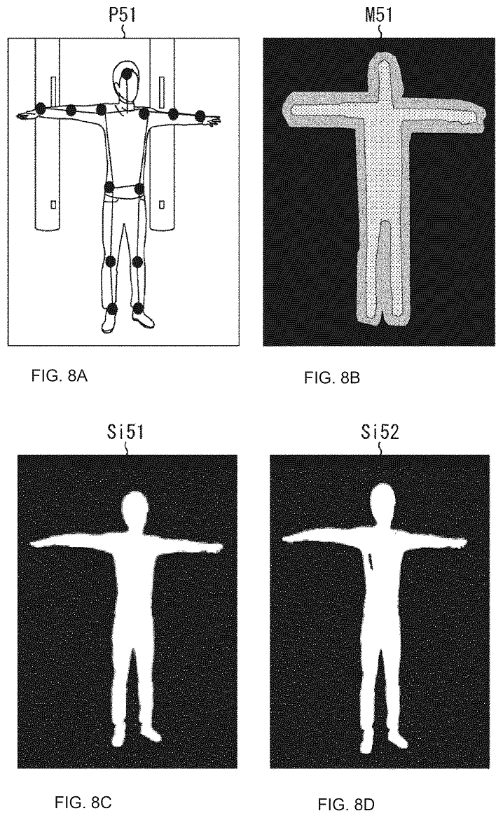

FIG. 8 is a diagram illustrating details of a method for generating a mask for graph cut and details of each silhouette image to be merged.

A of FIG. 8 illustrates a result of bone estimation on the captured image P51. Black substantial circles on the captured image P51 indicate positions of joints of the subject appearing in the captured image P51, and a straight line connecting each of the substantial circles indicates a bone of the subject.

For example, a region surrounded by the bones and a region around the bones are drawn as a region indicating a part of the foreground, a region having a predetermined width surrounding the region indicating a part of the foreground is drawn as a region for which it is unclear whether it is foreground or background, and a region other than these regions is drawn as a region indicating a part of the background. Thus, a mask M51 for graph cut illustrated in B of FIG. 8 is generated.

C of FIG. 8 illustrates a silhouette image Si51 acquired by graph cut using the mask M51, and D of FIG. 8 illustrates a silhouette image Si52 acquired by the learning-type foreground/background difference method.

In the mask M51 for graph cut, for example, a region surrounded by bones such as a trunk portion of the person is drawn as a region indicating a part of the foreground, and thus no hole is created in a portion corresponding to the trunk portion of the person in the silhouette indicated by the silhouette image Si51. On the other hand, in the silhouette indicated by the silhouette image Si52, a hole is created in a portion corresponding to the trunk portion of the person. The final silhouette image Si53 is, for example, an image in which the hole created in the silhouette indicated by the silhouette image Si52 is complemented on the basis of the silhouette indicated by the silhouette image Si52. Therefore, the silhouette indicated by the final silhouette image is a silhouette in which no hole is created.

Note that, in the graph cut, the edge of the silhouette is accurately extracted, but the accuracy of the edge may be lowered depending on the imaging situation. Therefore, which of the edge in the silhouette image Si51 and the edge in the silhouette image Si52 is used as the edge in the final silhouette image is determined according to the imaging situation. For example, the edge in the silhouette image Si51 is used as the edge of the silhouette corresponding to the upper body portion of the subject, and the edge in the silhouette image Si52 is used as the edge of the silhouette corresponding to the lower body portion of the subject.

As described above, in the present technology, by merging a silhouette image acquired by graph cut and a silhouette image acquired by the learning-type foreground/background difference method, it is possible to accurately extract a silhouette from the captured image, such as extracting a silhouette without a hole.

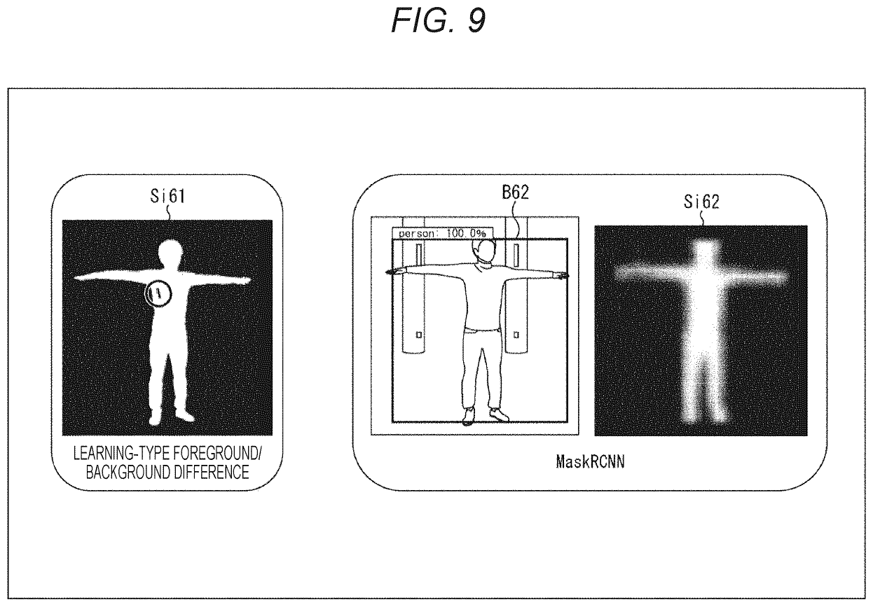

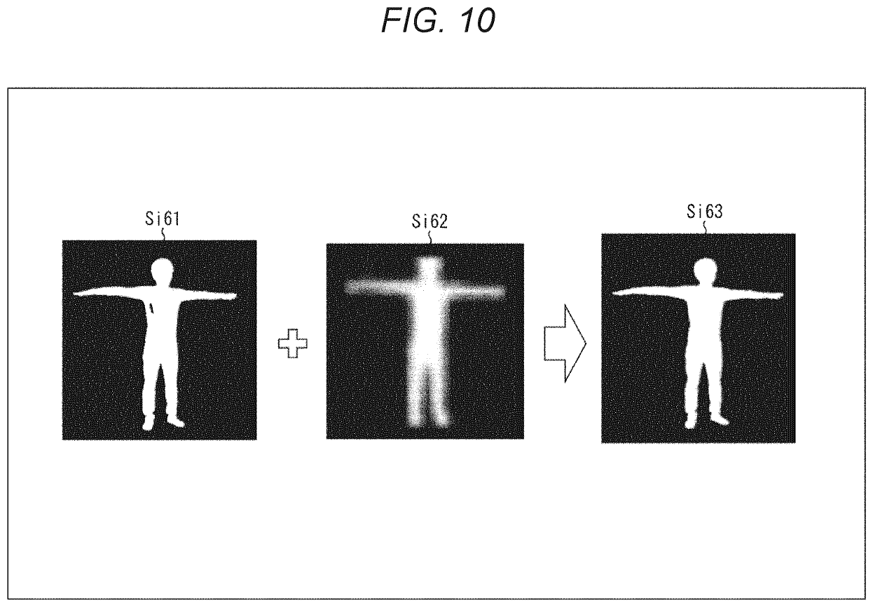

Next, a second example of silhouette image merging processing will be described with reference to FIGS. 9 and 10.

In the example of FIG. 9, a silhouette image Si61 is acquired by the learning-type foreground/background difference method, and a recognition result (bounding box B62 or the like) of the class of the object appearing in the captured image and a silhouette image Si62 are acquired by MaskRCNN.

As indicated by a circle on the left side of FIG. 9, a hole may be created in the silhouette indicated by the silhouette image Si61. As illustrated on the right side of FIG. 9, the silhouette indicated by the silhouette image Si62 indicates pixels having a high probability of capturing a person among the pixels of the captured image, and thus a region for which it would be unnatural if it had a missing part does not have a missing part.

As illustrated in FIG. 10, the silhouette image Si61 and the silhouette image Si62 are merged to generate a final silhouette image Si63. The final silhouette image Si63 is, for example, an image in which the hole created in the silhouette indicated by the silhouette image Si61 is complemented on the basis of the silhouette indicated by the silhouette image Si62. Therefore, the silhouette indicated by the final silhouette image is a silhouette in which a region for which it would be unnatural if it had a missing part does not have a missing part.

As described above, in the present technology, by merging a silhouette image acquired by MaskRCNN and a silhouette image acquired by the learning-type foreground/background difference method, it is possible to accurately extract a silhouette from the captured image, such as extracting a silhouette without a hole.

### 3. Configuration and Operation of Image Processing Device

### Configuration of Image Processing Device

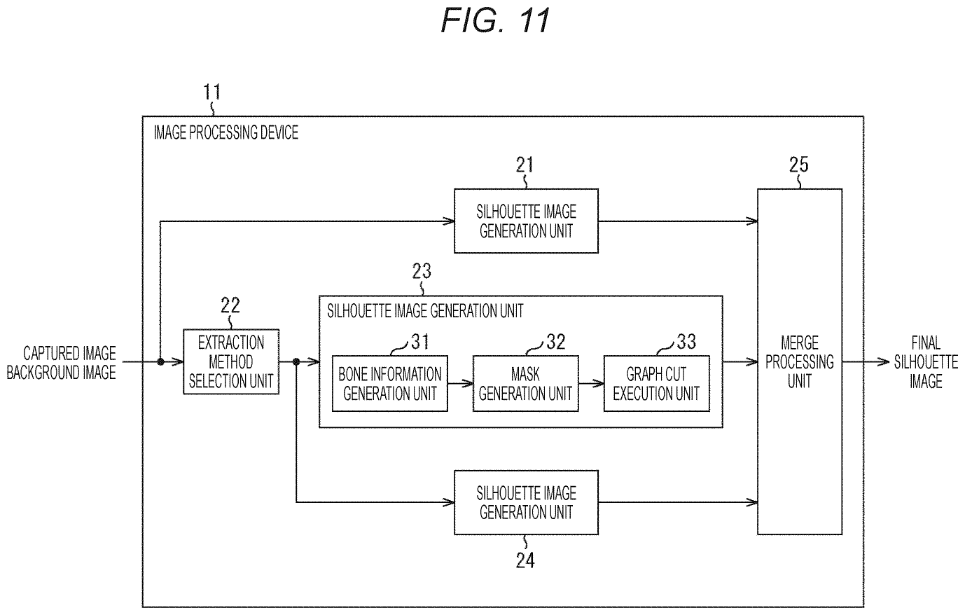

FIG. 11 is a block diagram illustrating a functional configuration example of an image processing device 11.

As described above, the image processing device 11 in FIG. 11 generates a final silhouette image by merging a silhouette image acquired by the graph cut or MaskRCNN with a silhouette image acquired by the learning-type foreground/background difference method.

As illustrated in FIG. 11, the image processing device 11 includes silhouette image generation units 21,23, and 24, an extraction method selection unit 22, and a merge processing unit 25.

The silhouette image generation unit 21 acquires one frame image constituting a captured image and a background image from, for example, a camera that images a subject, and inputs the frame image of the captured image and the background image to a learning model (first learning model) to generate a silhouette image. In other words, the silhouette image generation unit 21 acquires a silhouette image by the learning-type foreground/background difference method. The silhouette image generation unit 21 supplies the acquired silhouette image to the merge processing unit 25.

The extraction method selection unit 22 selects whether to perform graph cut or MaskRCNN.

Specifically, the extraction method selection unit 22 may select whether to perform graph cut or MaskRCNN on the basis of the silhouette image acquired by the learning-type foreground/background difference method. For example, in a case where the accuracy of the edge of the silhouette indicated by the silhouette image acquired by the silhouette image generation unit 21 is low, the extraction method selection unit 22 selects to perform graph cut. Furthermore, for example, in a case where a hole or a missing part is created in the silhouette indicated by the silhouette image acquired by the learning-type foreground/background difference method, the extraction method selection unit 22 selects to perform MaskRCNN.

Furthermore, the extraction method selection unit 22 may select whether to perform graph cut or MaskRCNN on the basis of an imaging situation (content of the captured image) such as the posture, the position (movement), and the color of clothes of the subject. For example, in a case where the accuracy of the edge of the silhouette indicated by the silhouette image acquired by the learning-type foreground/background difference method is estimated to be low on the basis of the posture of the subject, the extraction method selection unit 22 selects to perform graph cut. The imaging situation may be input by the user, or may be estimated on the basis of sensor data output from an external sensor or the captured image.

The extraction method selection unit 22 acquires the same frame image as the frame image of the captured image acquired by the silhouette image generation unit 21. The extraction method selection unit 22 supplies the frame image of the captured image to the silhouette image generation unit 23 in a case where performing the graph cut is selected, and supplies the frame image of the captured image to the silhouette image generation unit 24 in a case where performing MaskRCNN is selected.

The silhouette image generation unit 23 includes a bone information generation unit 31, a mask generation unit 32, and a graph cut execution unit 33.

The bone information generation unit 31 performs bone estimation of the subject appearing in the frame image of the captured image supplied from the extraction method selection unit 22, and generates bone information indicating a result of the bone estimation. The bone information generation unit 31 supplies the bone information and the frame image of the captured image to the mask generation unit 32.

The mask generation unit 32 generates a mask for graph cut on the basis of the bone information supplied from the bone information generation unit 31, and supplies the mask for graph cut and the frame image of the captured image to the graph cut execution unit 33.

Using the mask supplied from the mask generation unit 32, the graph cut execution unit 33 executes graph cut on the frame image of the captured image to generate a silhouette image. The graph cut execution unit 33 supplies the acquired silhouette image to the merge processing unit 25.

The silhouette image generation unit 24 executes MaskRCNN processing on the frame image of the captured image supplied from the extraction method selection unit 22 to generate a silhouette image. Specifically, the silhouette image generation unit 24 generates a silhouette image by inputting a frame image of a captured image to a learning model (second learning model) that recognizes a region of an object in a captured image and a class indicated by the region of the object, and performing conversion processing on a mask output from the learning model. The silhouette image generation unit 24 supplies the acquired silhouette image to the merge processing unit 25.

The merge processing unit 25 generates the final silhouette image by merging the silhouette image supplied from the silhouette image generation unit 21 with the silhouette image supplied from the silhouette image generation unit 23 or the silhouette image supplied from the silhouette image generation unit 24. For example, on the basis of the silhouette image supplied from the silhouette image generation unit 23 or the silhouette image supplied from the silhouette image generation unit 24, the merge processing unit 25 generates the final silhouette image by complementing at least one of the edge or the inside of the silhouette indicated by the silhouette image supplied from the silhouette image generation unit 21.

For example, a 3D model of a subject is generated by a method such as Visual Hull using a plurality of final silhouette images generated on the basis of a plurality of captured images captured from a plurality of viewpoints.

Note that, although it has been described that one frame image constituting the captured image is supplied to each silhouette image generation unit, a frame image group constituting a captured image may be supplied to each silhouette image generation unit, and the frame image groups may be processed collectively.

Instead of generating the final silhouette image corresponding to all the frame images constituting the captured image, only the final silhouette image corresponding to the frame image with low accuracy of the silhouette image acquired by the learning-type foreground/background difference method may be generated, and the silhouette image with high accuracy of the silhouette image acquired by the learning-type foreground/background difference method may be used as it is for generating the 3D model without being merged. For example, in a case where a missing part is created in the silhouette indicated by the silhouette image acquired by the learning-type foreground/background difference method, this silhouette image and the silhouette image acquired by graph cut or MaskRCNN are merged.

### Operation of Image Processing Device

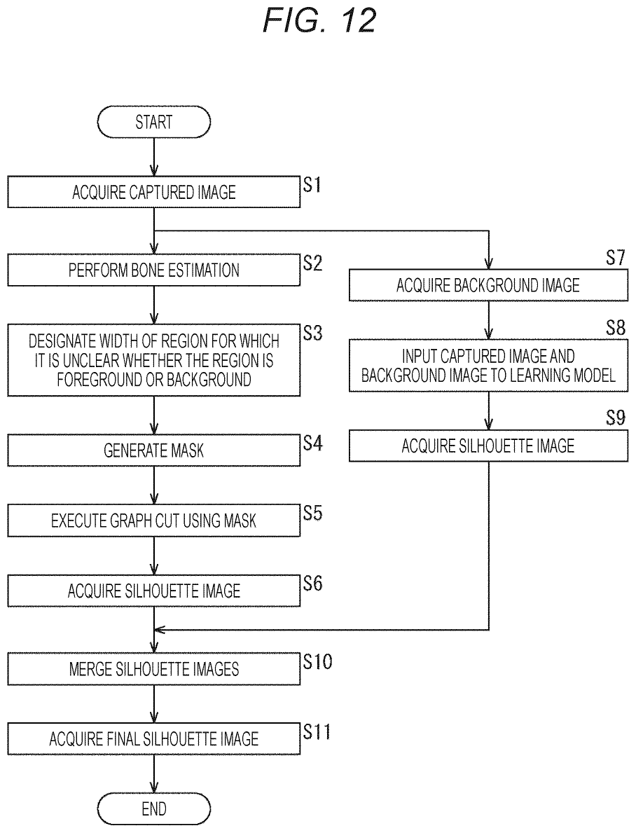

Processing performed by the image processing device 11 in a case where a silhouette image acquired by the learning-type foreground/background difference method and a silhouette image acquired by graph cut are merged will be described with reference to the flowchart of FIG. 12.

In step S1, the silhouette image generation unit 21 and the silhouette image generation unit 23 acquire a captured image.

In step S2, the bone information generation unit 31 performs bone estimation of a subject appearing in the captured image and generates bone information.

In step S3, the mask generation unit 32 designates a width of a region that is drawn in the mask for graph cut and for which it is unclear whether the region is foreground or background. The width of the region for which it is unclear whether it is foreground or background is designated, for example, on the basis of the posture of the subject, or a value input in advance by the user is designated.

In step S4, the mask generation unit 32 generates a mask for graph cut on the basis of the bone information. Specifically, the mask generation unit 32 generates a mask for graph cut by drawing a region surrounded by the bones and a region around the bones as a region indicating a part of the foreground, drawing a region for which it is unclear whether it is foreground or background so as to surround the region indicating a part of the foreground with a designated width, and drawing a region other than these regions as a region indicating a part of the background.

In step S5, the graph cut execution unit 33 performs graph cut on the captured image using the mask.

In step S6, the graph cut execution unit 33 performs conversion processing of an image including only the foreground generated by the graph cut to acquire a silhouette image.

Note that the processing of steps S7 to S9 is executed in parallel with the processing of steps S2 to S6.

In step S7, the silhouette image generation unit 21 acquires a background image.

In step S8, the silhouette image generation unit 21 inputs the captured image and the background image to a learning model.

In step S9, the silhouette image generation unit 21 acquires the silhouette image output from the learning model.

In step S10, the merge processing unit 25 merges the silhouette image acquired by graph cut in step S6 with the silhouette image acquired by the learning-type foreground/background difference method in step S9.

In step S11, the merge processing unit 25 acquires a final silhouette image acquired by merging the two captured images.

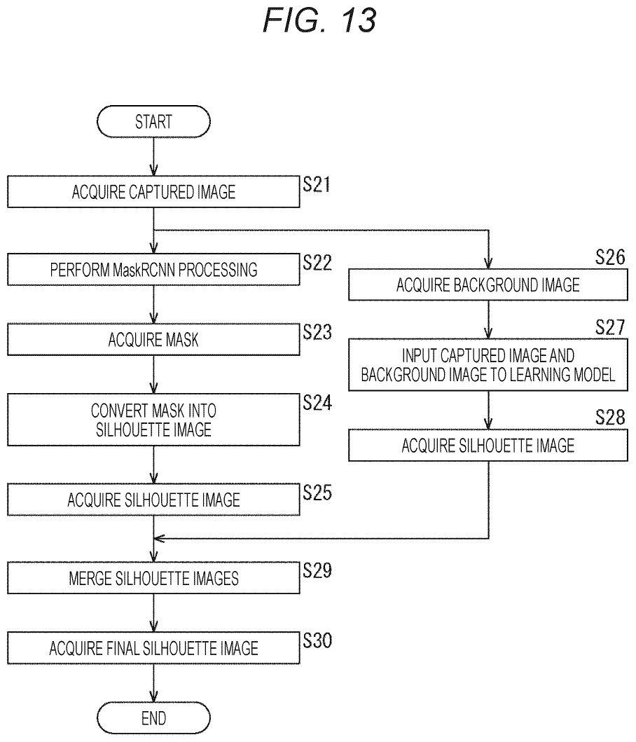

Next, processing performed by the image processing device 11 in a case where a silhouette image acquired by the learning-type foreground/background difference method and a silhouette image acquired by MaskRCNN are merged will be described with reference to a flowchart in FIG. 13.

In step S21, the silhouette image generation unit 21 and the silhouette image generation unit 24 acquire a captured image.

In step S22, the silhouette image generation unit 24 executes MaskRCNN processing on the captured image. Specifically, the silhouette image generation unit 24 inputs the captured image to the learning model.

In step S23, the silhouette image generation unit 24 acquires the mask output from the learning model.

In step S24, the silhouette image generation unit 24 performs conversion processing of converting the mask into a silhouette image.

In step S25, the silhouette image generation unit 24 acquires a silhouette image by the conversion processing.

Note that the processing of steps S26 to S28 is executed in parallel with the processing of steps S22 to S25. The processing in steps S26 to S28 is the same as the processing in steps S7 to S9 in FIG. 12. In steps $26 to S28, the silhouette image is acquired by the learning-type foreground/background difference method.

In step S29, the merge processing unit 25 merges the silhouette image acquired by MaskRCNN in step S25 with the silhouette image acquired by the learning-type foreground/background difference method in step S28.

In step S30, the merge processing unit 25 acquires a final silhouette image acquired by merging the two captured images.

With the above processing, the image processing device 11 according to the present technology can accurately extract a silhouette from the captured image, such as extracting a silhouette without a hole, by merging a silhouette image acquired by graph cut or MaskRCNN with a silhouette image acquired by the learning-type foreground/background difference method.

### 4. Modifications

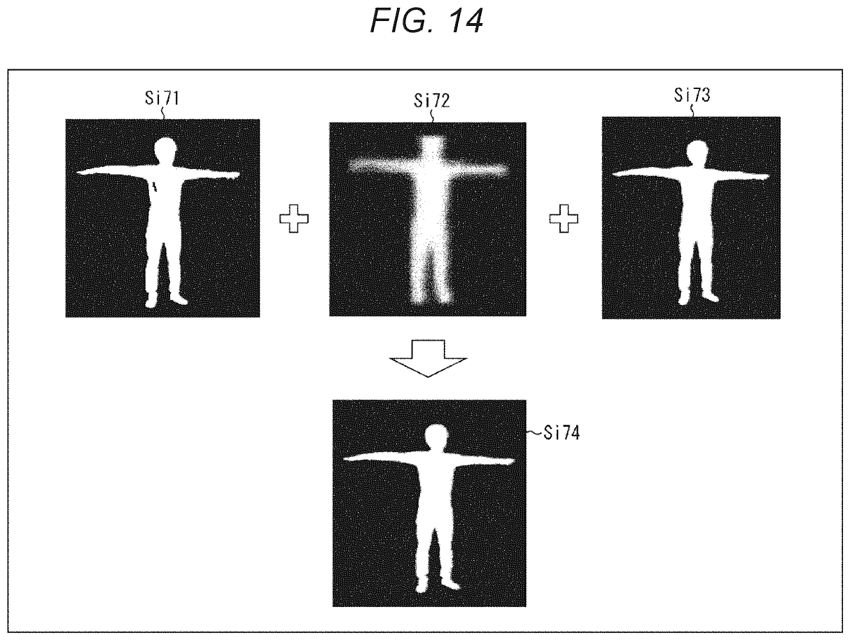

FIG. 14 is a diagram illustrating a third example of silhouette image merging processing.

As illustrated in FIG. 14, a silhouette image Si71 acquired by the learning-type foreground/background difference method, a silhouette image Si72 acquired by MaskRCNN, and a silhouette image Si73 acquired by graph cut may be merged to generate a final silhouette image Si74.

The final silhouette image Si74 is, for example, an image in which a hole created in the silhouette indicated by the silhouette image Si71 is complemented on the basis of the silhouettes indicated by the silhouette image Si72 and the silhouette image Si73. The more accurate one of the edge in the silhouette image Si71 and the edge in the silhouette image Si73 is used as the edge of the silhouette indicated by the final silhouette image Si74.

As described above, it is possible to generate a final silhouette image in which a silhouette is accurately extracted from a captured image by using a silhouette image acquired by graph cut and a silhouette image acquired by MaskRCNN, and complementing portions, such as the edge and the inside, that each of the methods, graph cut and MaskRCNN, excels at, with a silhouette image acquired by the learning-type foreground/background difference method.

### Regarding Computer

The above-described series of processing can be performed by hardware or can be performed by software. In a case where the series of processing steps is executed by software, a program included in the software is installed from a program recording medium on a computer incorporated in dedicated hardware, a general-purpose personal computer, or the like.

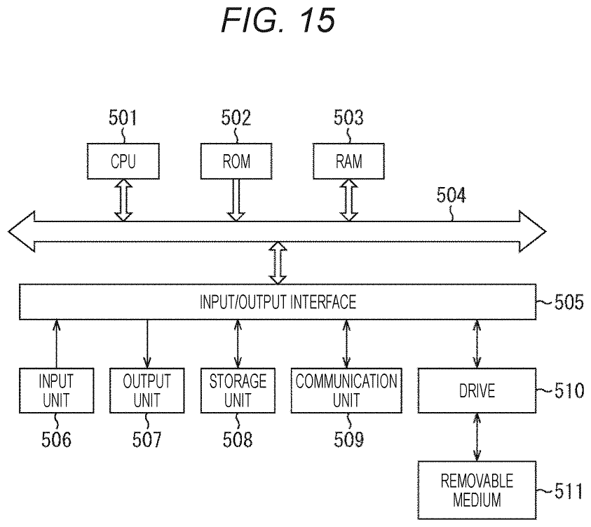

FIG. 15 is a block diagram illustrating a configuration example of hardware of the computer that executes the series of processing described above according to the program.

The CPU 501, the ROM 502, and the RAM 503 are connected to one another by a bus 504.

An input/output interface 505 is further connected to the bus 504. An input unit 506 including a keyboard, a mouse, and the like, and an output unit 507 including a display, a speaker, and the like are connected to the input/output interface 505. Furthermore, a storage unit 508 including a hard disk, a nonvolatile memory, or the like, a communication unit 509 including a network interface or the like, and a drive 510 that drives a removable medium 511 are connected to the input/output interface 505.

In the computer configured as described above, for example, the CPU 501 loads a program stored in the storage unit 508 into the RAM 503 via the input/output interface 505 and the bus 504 and executes the program to execute the above-described series of processing.

For example, the program executed by the CPU 501 is recorded in the removable medium 511, or provided via a wired or wireless transmission medium such as a local area network, the Internet, or digital broadcasting, and then installed in the storage unit 508.

The program executed by the computer may be a program in which the processing is performed in time series in the order described in the present description, or may be a program in which the processing is performed in parallel or at a necessary timing such as when a call is made.

Note that the effects described in the present description are merely examples and are not limited, and other effects may be provided.

An embodiment of the present technology is not limited to the above-described embodiment, and various modifications can be made without departing from the scope of the present technology.

For example, the present technology may be embodied in cloud computing in which one function is shared and executed by a plurality of devices via a network.

Further, each step described in the flowchart described above can be performed by one device or can be shared and performed by a plurality of devices.

Moreover, in a case where a plurality of pieces of processing is included in one step, the plurality of pieces of processing included in the one step can be executed by one device or executed by a plurality of devices in a shared manner.

### Combination Examples of Configurations

The present technology can also be configured as follows.

(1)

An image processing device including

a merge processing unit configured to merge a first silhouette image output from a first learning model that takes, as input, a captured image in which a subject and a background appear and a background image in which the background appears, and outputs a silhouette image indicating a region of the subject in the captured image, and a second silhouette image generated by using a method for generating the silhouette image by performing object recognition on the captured image.

(2)

The image processing device according to (1), in which

the merge processing unit is configured to complement at least one of an edge or an inside of a region of the subject indicated by the first silhouette image on the basis of the second silhouette image.

(3)

The image processing device according to (2), in which

the second silhouette image is generated by a method of performing bone estimation of the subject appearing in the captured image as the object recognition and generating the silhouette image on the basis of a result of the bone estimation.

(4)

The image processing device according to (3), in which

the second silhouette image is generated on the basis of information indicating a part of a region of the subject in the captured image generated on the basis of a result of the bone estimation.

(5)

The image processing device according to (4), in which

the second silhouette image is generated by graph cut using a mask indicating a region of the subject in the captured image.

(6)

The image processing device according to (5), in which a region of the subject in the captured image includes a region surrounded by a bone acquired by the bone estimation and a region around the bone.

(7)

The image processing device according to (2), in which

the second silhouette image is generated on the basis of a recognition result by a second learning model that takes the captured image as input, and recognizes a region of an object in the captured image and a class indicated by the region of the object.

(8)

The image processing device according to (7), in which

the merge processing unit is configured to perform bone estimation of the first silhouette image, the second silhouette image, and the subject appearing in the captured image, and merge a third silhouette image generated using a method for generating the silhouette image on the basis of a result of the bone estimation.

(9)

The image processing device according to any one of (1) to (8), in which

a method for generating the second silhouette image is determined on the basis of the first silhouette image.

(10)

The image processing device according to any one of (1) to (8), in which

a method for generating the second silhouette image is determined on the basis of at least one of a posture, a position, or a color of clothes of the subject.

(11)

An image processing method including

merging, using an image processing device, a first silhouette image output from a first learning model that takes, as input, a captured image in which a subject and a background appear and a background image in which the background appears, and outputs a silhouette image indicating a region of the subject in the captured image, and a second silhouette image generated by using a method for generating the silhouette image by performing object recognition on the captured image.

(12)

A program for causing a computer to execute processing of

merging a first silhouette image output from a first learning model that takes, as input, a captured image in which a subject and a background appear and a background image in which the background appears, and outputs a silhouette image indicating a region of the subject in the captured image, and a second silhouette image generated by using a method for generating the silhouette image by performing object recognition on the captured image.

### Reference Signs List

11 Image processing device
21 Silhouette image generation unit
22 Extraction method selection unit
23,24 Silhouette image generation unit
25 Merge processing unit
31 Bone information generation unit
32 Mask generation unit
33 Graph cut execution unit

1. An image processing device comprising
a merge processing unit configured to merge a first silhouette image output from a first learning model that takes, as input, a captured image in which a subject and a background appear and a background image in which the background appears, and outputs a silhouette image indicating a region of the subject in the captured image, and a second silhouette image generated by using a method for generating the silhouette image by performing object recognition on the captured image.

2. The image processing device according to claim 1, wherein
the merge processing unit is configured to complement at least one of an edge or an inside of a region of the subject indicated by the first silhouette image on a basis of the second silhouette image.

3. The image processing device according to claim 2, wherein
the second silhouette image is generated by a method for performing bone estimation of the subject appearing in the captured image as the object recognition and generating the silhouette image on a basis of a result of the bone estimation.

4. The image processing device according to claim 3, wherein
the second silhouette image is generated on a basis of information indicating a part of a region of the subject in the captured image generated on a basis of a result of the bone estimation.

5. The image processing device according to claim 4, wherein
the second silhouette image is generated by graph cut using a mask indicating a region of the subject in the captured image.

6. The image processing device according to claim 5, wherein
a region of the subject in the captured image includes a region surrounded by a bone acquired by the bone estimation and a region around the bone.

7. The image processing device according to claim 2, wherein
the second silhouette image is generated on a basis of a recognition result by a second learning model that takes the captured image as input, and recognizes a region of an object in the captured image and a class indicated by the region of the object.

8. The image processing device according to claim 7, wherein
the merge processing unit is configured to perform bone estimation of the first silhouette image, the second silhouette image, and the subject appearing in the captured image, and merge a third silhouette image generated using a method for generating the silhouette image on a basis of a result of the bone estimation.

9. The image processing device according to claim 1, wherein
a method for generating the second silhouette image is determined on a basis of the first silhouette image.

10. The image processing device according to claim 1, wherein
a method for generating the second silhouette image is determined on a basis of at least one of a posture, a position, or a color of clothes of the subject.

11. An image processing method comprising
merging, using an image processing device, a first silhouette image output from a first learning model that takes, as input, a captured image in which a subject and a background appear and a background image in which the background appears, and outputs a silhouette image indicating a region of the subject in the captured image, and a second silhouette image generated by using a method for generating the silhouette image by performing object recognition on the captured image.

12. A program for causing a computer to execute processing of
merging a first silhouette image output from a first learning model that takes, as input, a captured image in which a subject and a background appear and a background image in which the background appears, and outputs a silhouette image indicating a region of the subject in the captured image, and a second silhouette image generated by using a method for generating the silhouette image by performing object recognition on the captured image.
